(19) United States
(12) Patent Application Publication
(10) Pub. No.: US 2010/0182517 A1
(43) Pub. Date: Jul. 22, 2010

(54) COLD CATHODE TUBE LAMP, LIGHTING DEVICE FOR DISPLAY DEVICE, DISPLAY DEVICE, AND TELEVISION RECEIVING DEVICE

(75) Inventor: Yoshiki Takata, Osaka-shi (JP)

Correspondence Address: SHARP KABUSHIKI KAISHA;C/O KEATING & BENNETT, LLP, 1800 Alexander Bell Drive, SUITE 200, Reston, VA, 20191, US

(73) Assignee: SHARP KABUSHIKI KAISHA, Osaka-shi, Osaka (JP)

(21) Appl. No.: 12/677,174

(22) PCT Filed: Apr. 9, 2008
(86) PCT No.: PCT/JP2008/056979

§ 371 Date: Mar. 9, 2010

(30) Foreign Application Priority Data
Sep. 11, 2007 (JP) 2007-235326

(51) Int. Cl. G02F 1/13357; H01J 61/067; H01J 61/12

(52) U.S. Cl. 348/790; 313/631; 313/574

(57) ABSTRACT

This cold cathode tube lamp comprises: a discharge tube composed of a glass tube (11) having at least a rare gas sealed therein and a pair of electrodes (21, 22) arranged opposite each other inside the glass tube (11) at opposite ends thereof. The electrodes (21, 22) have cylindrical portions (21a, 22a) having a cylindrical shape with an opening at one end and bottom portions (21b, 22b) closing the other end of the cylindrical portions (21a, 22a). Projecting portions (41, 42) are formed on interior surfaces of the cylindrical portions (21a, 22a).

### TECHNICAL FIELD

The present invention relates to a cold cathode tube lamp, and more particularly to a cold cathode tube lamp having an electrode for a cold cathode tube, the electrode having a shape of a cup.

### BACKGROUND ART

Conventionally, cold cathode tube lamps are used as a light source in various devices. For their low power consumption and long life spans as a light source, cold cathode tube lamps are used as a light source (backlight) in, for example, liquid crystal display devices and the like.

FIG. 8 is a sectional view showing the structure of a conventional cold cathode tube lamp. Referring to FIG. 8, a conventional cold cathode tube lamp will now be described. As shown in FIG. 8, the conventional cold cathode tube lamp is provided with a glass tube 401 having an outer diameter of about 1.5 mm to about 4.0 mm (an inner diameter of about 1.0 mm to about 3.0 mm), and with electrodes 402 and 403 forming a pair of cold cathodes arranged opposite each other inside the glass tube 401 at opposite ends thereof. As shown in FIG. 8, the electrodes 402 and 403 have the shape of a cup with an outer diameter of about 1.2 mm to about 2.0 mm, and with an overall length of about 4.0 mm to about 7.0 mm. Furthermore, as shown in FIG. 8, lead terminals 404 and 405 are connected to the electrodes 402 and 403 respectively; the other ends of the lead terminals 404 and 405 are brought out of the glass tube 401. The glass tube 401 is airtightly sealed and hermetically closed by the lead terminals 404 and 405. Although unillustrated, a fluorescent substance is applied to the interior wall of the glass tube 401, and a rare gas, such as argon or neon, along with mercury is, as a discharge gas, sealed inside the glass tube 401.

When a voltage is applied between the electrodes 402 and 403 of a cold cathode tube lamp as described above via the lead terminals 404 and 405, a tiny number of electrons present inside the glass tube 401 are attracted to and collide with the electrode. As a result, from the electrode hit by electrons, secondary electrons are emitted, starting electric discharge; the emitted electrons collide with the atoms of the mercury inside the glass tube 401, which produces ultraviolet radiation. The ultraviolet radiation excites the fluorescent substance applied to the interior surface of the glass tube 401, causing visible rays to be emitted.

However, after use for a long time, cold cathode tube lamps suffer a phenomenon (sputtering) in which ions or the like colliding with an electrode expel atoms from the metal material forming the electrode. When sputtering occurs, the atoms (sputtered matter) of the electrode metal expelled by sputtering combine with the mercury sealed inside a glass tube, and thus the mercury to be used for electric discharge is consumed disadvantageously. Consumption of the mercury makes ultraviolet radiation to be diminished, and thus light emission is lowered, leading to diminished luminance in lamps. This leads to a problem of shortening of the life span of the cold cathode tube lamp. Moreover, in a case with an electrode having the shape of a cup, collision of ions or the like occurs in a concentrated fashion on the interior surface of a bottom part of the electrode, and thus, ascribable to sputtering occurring in a concentrated fashion on the interior surface of the bottom part of the electrode, a hole penetrating the bottom part of the electrode may be produced, or in some cases the electrode may even drop off, resulting in breakage of the electrode.

As a way to solve shorter life spans resulting from sputtering as described above, a method is known which involves increasing the thickness of an electrode (see, for example, Patent Document 1 listed below). Patent Document 1 discloses an electrode having the shape of a cup, of which a bottom part and side surface part near the bottom part are formed to have a thickness larger than that of an opening of the electrode. In the electrode disclosed in Patent Document 1, since the bottom part of the electrode and the side surface part near the bottom part of the electrode have a thickness larger than that of the opening of the electrode, even when sputtering occurs in a concentrated fashion on the bottom part, or on the side surface part near the bottom part, of the electrode, it is possible to suppress wearing in the electrode at its bottom part or its side surface part. This makes it possible to suppress breakage of the electrode, and thereby to suppress shortening of the life span of the cold cathode tube lamp.
Patent Document 1: JP-A-2007-141593

### DISCLOSURE OF THE INVENTION

### Problems to be Solved by the Invention

In the electrode disclosed in above-mentioned Patent Document 1, however, the sputtered matter produced by sputtering can easily scatter from the electrode into a glass tube, and thus the sputtered matter scattered into the glass tube easily combines with the mercury inside the glass tube, causing mercury to be consumed inconveniently. This leads to a problem of diminished luminance in the cold cathode tube lamp and hence shortening of the life span of the cold cathode tube lamp.

In the meantime, in recent years, further improvements have been sought in backlights for lower power consumption, longer life spans, higher efficiency, etc. For example, it is known that reducing the gas pressure inside a glass tube and passing a large current helps improve light emission efficiency. Reducing the gas pressure inside the glass tube, however, by increasing the movement speed of ions etc., makes sputtering more likely to occur, and, ascribable to the sputtering, there may arise a problem of shortening of the life span of the cold cathode tube lamp. One possible way to solve this problem is, for example, to increase the tube diameter of the glass tube.

In a case where the tube diameter of the glass tube is increased, however, when an electrode is used that has a similar size to the conventional one, since the distance between the interior wall of the glass tube and the electrode is large, ions or the like not only collide with an interior part of the electrode, but also collide with an exterior part of the electrode. Thus, sputtering is more likely to occur, and thus breakage of electrode resulting from sputtering is more likely to occur, which is a problem. Moreover, increased size of the electrode along with the increased tube diameter of the glass tube results in an increased internal diameter of the electrode, and thus ions or the like can easily collide with the interior surface of the electrode. This causes sputtering more likely to occur in a concentrated fashion on the interior surface of a bottom part of the electrode and on the inner side surface near the bottom part of the electrode, and thus breakage of the electrode resulting from sputtering is more likely to occur, which is a problem. Moreover, increased inner diameter of the electrode enables the sputtered matter produced by sputtering to scatter from the electrode into the glass tube easily, and thus by the sputtered matter combining with the mercury inside the glass tube, the mercury is consumed disadvantageously.

Moreover, in a case where the size of an electrode is increased as described above, the load on a lead terminal supporting the electrode increases, possibly causing deformation or breakage at the joint between the lead terminal and the electrode. Enlarging the electrode also increases heat generation of the electrode, and thus, ascribable to the heat generated, there may arise disadvantages such as lower light emission efficiency and, as a result of the heat generated in the electrode concentrating on the lead terminal, heat-induced damage to an end metal or circumferential connector connected to the lead terminal.

The present invention is devised to overcome inconveniences as described above, and it is an object of the invention to provide a cold cathode tube lamp, a lighting device for display device, a display device, and a television receiving device that offer enhanced stability of electrodes.

### Means for Solving the Problem

To achieve the above object, according to the invention, a cold cathode tube lamp comprises a discharge tube composed of a glass tube having at least a rare gas sealed therein and a pair of electrodes arranged opposite each other inside the glass tube at opposite ends thereof, wherein the electrodes have a cylindrical portion having a cylindrical shape with an opening at one end and a bottom portion closing the other end of the cylindrical portion, and, on an inner side surface of the cylindrical portion, a projecting portion is formed.

With the above configuration, in the cold cathode tube lamp, the electrodes have the cylindrical portion having a cylindrical shape with an opening at one end and the bottom portion closing the other end of the cylindrical portion, and the projecting portion is formed on the inner side surface of the cylindrical portion of the electrodes. This makes it possible to prevent ions or the like from reaching the interior surface of a bottom part of the electrodes and the inner side surface of the cylindrical portion near the bottom part of the electrodes; thus, it is possible to suppress collision of the ions or the like concentrating on the interior surface of the bottom part of the electrodes and on the inner side surface of the cylindrical portion near the bottom part of the electrodes. Thus, it is possible to suppress shortening of the life span of the cold cathode tube lamp ascribable to breakage of the electrodes resulting from sputtering. Moreover, part of sputtered matter, which is produced by ions or the like colliding with the interior surface of the bottom part of the electrodes and the inner side surface of the cylindrical portion near the bottom part of the electrodes, collides with the projecting portion, and thus the sputtered matter can be prevented from scattering into the glass tube. In this way, combining of the sputtered matter with mercury is suppressed, and thus it is possible to suppress shortening of the life span of the cold cathode tube lamp ascribable to consumption of mercury.

In the cold cathode tube lamp with the above configuration, preferably, the projecting portion is formed in a region between the opening and the middle part with respect to the overall length of the electrodes. With this configuration, it is possible to effectively prevent ions or the like from reaching the interior surface of the bottom part of the electrodes and the inner side surface of the cylindrical portion near the bottom part of the electrodes, and to suppress occurrence of sputtering in a concentrated fashion in the region between the projecting portion and the opening. In this way, it is possible to suppress breakage of the electrodes resulting from sputtering, and thus it is possible to suppress shortening of the life span of the cold cathode tube lamp.

In the cold cathode tube lamp with the above configuration, preferably, the projecting portion has a thickness of 1/20 times to ¼ times the inner diameter of the electrodes. With this configuration, it is possible to easily prevent ions or the like from colliding in a concentrated fashion with the interior surface of the bottom part of the electrodes and the inner side surface of the cylindrical portion near the bottom part of the electrode, and to prevent the sputtered matter produced by sputtering from scattering into the glass tube. In this way, it is possible to easily suppress breakage of the electrodes resulting from sputtering, and to suppress consumption of mercury due the sputtered matter produced by sputtering scattering into the glass tube and combining with mercury. This makes it possible to suppress shortening of the life span of the cold cathode tube lamp.

In the cold cathode tube lamp with the above configuration, preferably, the electrodes have an outer diameter of 0.5 times to 1.0 time the overall length of the electrodes.

In the cold cathode tube lamp with the above configuration, preferably, the glass tube has an inner diameter of 3 mm or more. With this configuration, it is possible to increase the tube diameter of the cold cathode tube lamp, and thus, by passing a large current through the cold cathode tube lamp, it is possible to obtain a sufficient amount of light and to enhance light emission efficiency.

In the cold cathode tube lamp with the above configuration, preferably, the total gas pressure of the rare gas sealed inside the glass tube is 50 Torr or less. With this configuration, the light emission efficiency can be enhanced.

In the cold cathode tube lamp with the above configuration, preferably, the electrodes are made of at least one metal material selected from the group of W, Nb, Mo, and Ni. With this configuration, the influence of sputtering can be reduced, and thus it is possible to suppress wearing in or breakage of the electrodes resulting from sputtering and to suppress production of sputtered matter. This makes it possible to suppress shortening of the life span of the cold cathode tube lamp.

To achieve the above object, according to the invention, a lighting device of display device comprises the cold cathode tube lamp described above.

With the above configuration, as a result of the lighting device for display device being provided with the cold cathode tube lamp described above, it is possible to suppress shortening of the life span of the cold cathode tube lamp resulting from sputtering, and thus it is possible to suppress inconveniences such as diminished luminance in the lighting device for display device resulting from shortening of the life span of the cold cathode tube lamp.

To achieve the above object, according to the invention, a display device comprises the lighting device for display device described above.

With the above configuration, as a result of the display device being provided with the lighting device for display device described above, since inconveniences such as diminished luminance in the display device resulting from shortening of the life span of the cold cathode tube lamp, it is possible to enhance the reliability of the display device.

To achieve the above object, according to the invention, a television receiving device comprises the display device described above.

With the above configuration, as a result of the television receiving device being provided with the display device described above, inconveniences are suppressed such as diminished luminance in the display device resulting from shortening of the life span of the cold cathode tube lamp, and thus it is possible to enhance the reliability of the television receiving device.

### Advantages of the Invention

As described above, according to the present invention, it is possible to obtain a cold cathode tube lamp that offer enhanced stability of electrodes, and to obtain a lighting device for display device, a display device, and a television receiving device, all of which employ such a cold cathode tube lamp.

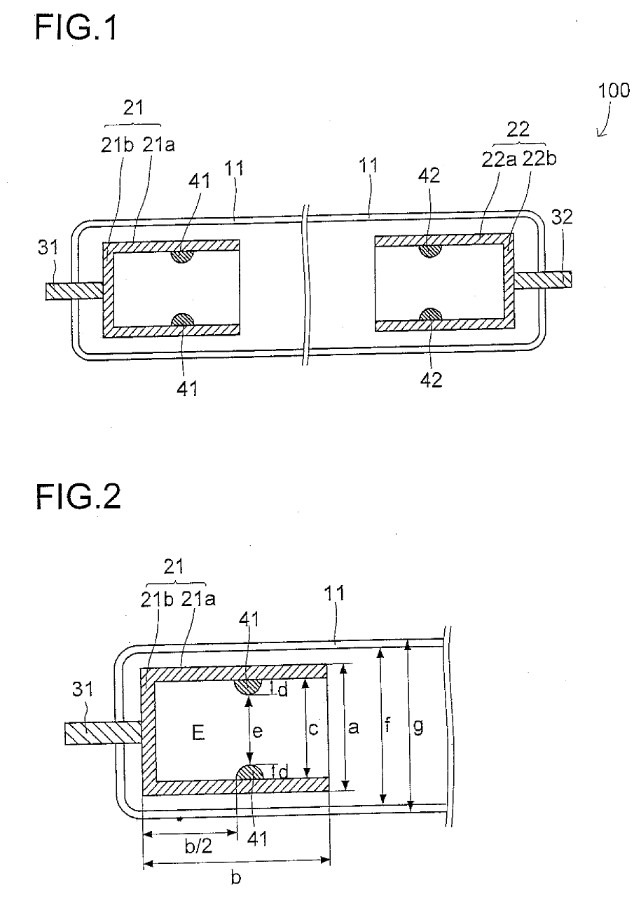

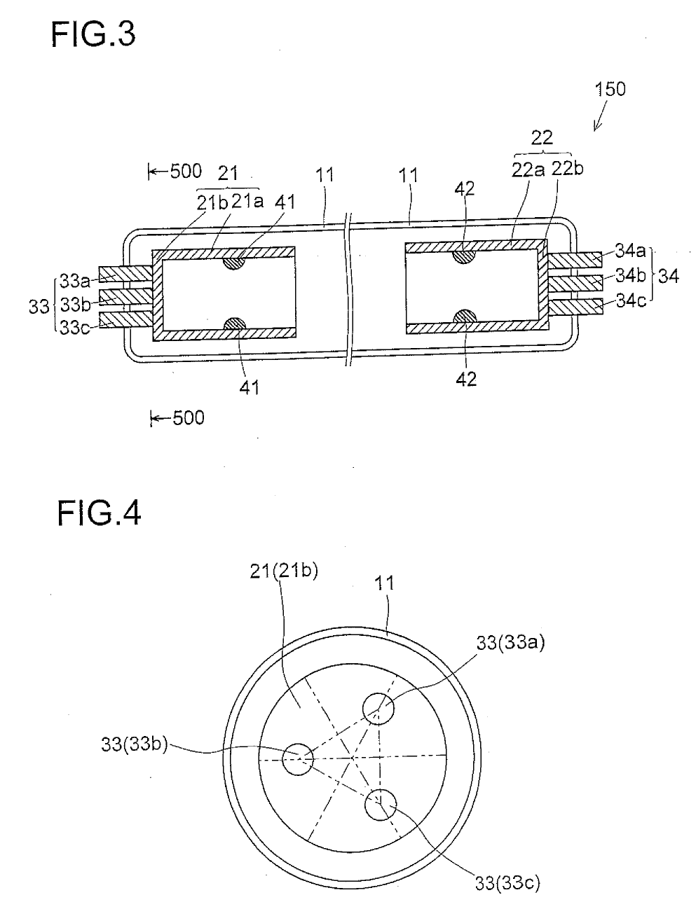

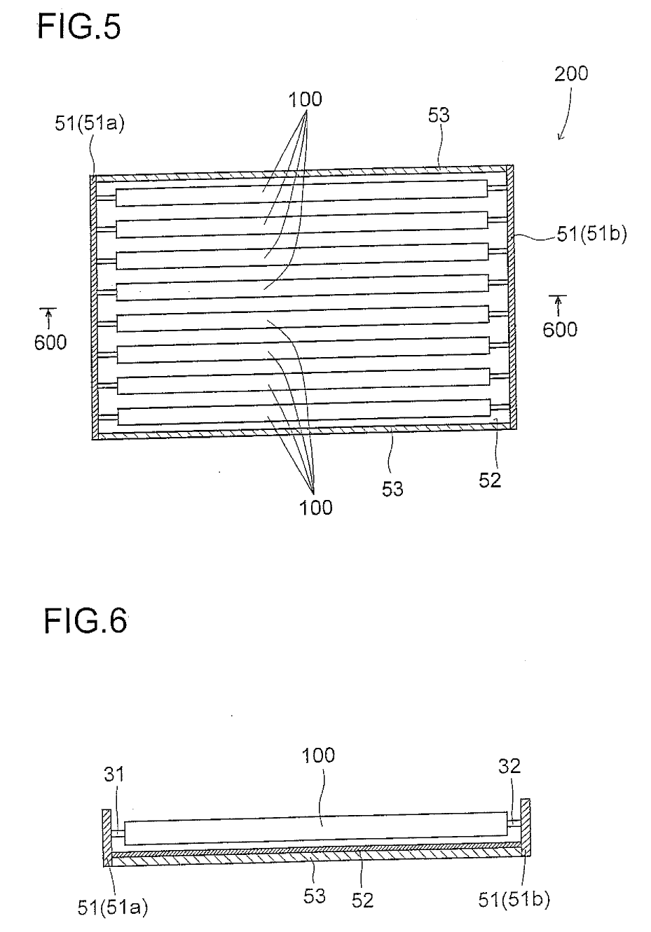

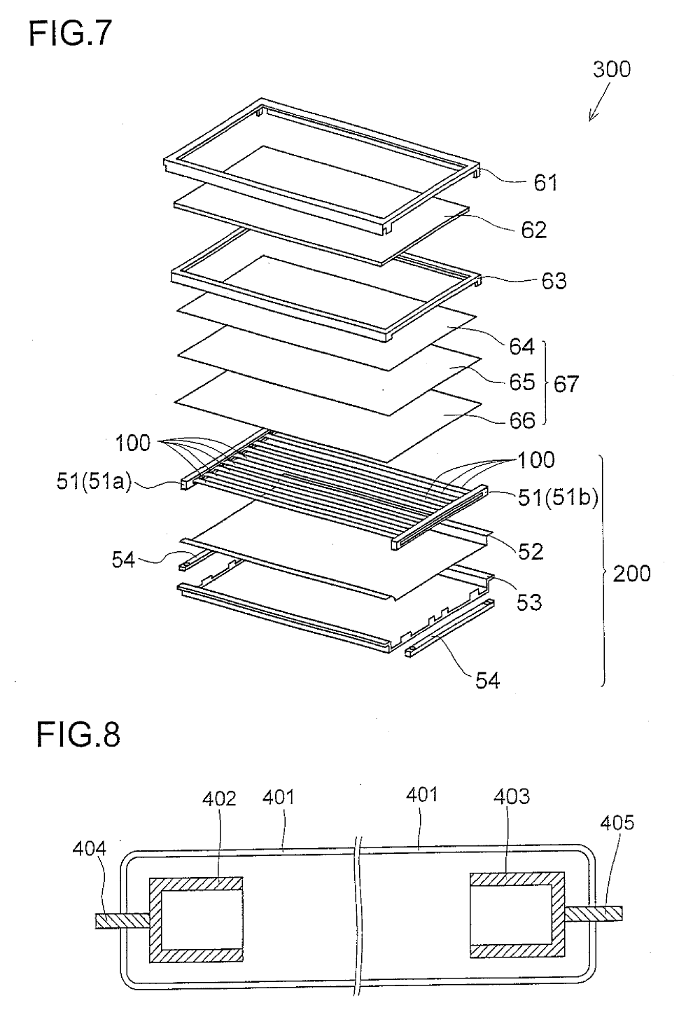

### BRIEF DESCRIPTION OF DRAWINGS

[FIG. 1] A sectional view showing the structure of a cold cathode tube lamp according to a first embodiment.

[FIG. 2] An enlarged sectional view of a part of the cold cathode tube lamp shown in FIG. 1.

[FIG. 3] A sectional view showing the structure of a cold cathode tube lamp according to a second embodiment.

[FIG. 4] A sectional view taken along line 500-500 in FIG. 3.

[FIG. 5] A schematic diagram of a lighting device for display device according to a third embodiment.

[FIG. 6] A sectional view taken along line 600-600 in FIG. 5.

[FIG. 7] An exploded perspective view of a liquid crystal display device according to a fourth embodiment.

[FIG. 8] A sectional view showing conventional electrodes for cold cathode tube.

### LIST OF REFERENCE SYMBOLS

11 glass tube

21, 22 electrode

21a, 22a cylindrical portion

21b, 22b bottom portion

31, 32, 33, 34 lead terminal

41, 42 projecting portion

100, 150 cold cathode tube lamp

200 lighting device for display device

300 liquid crystal display device

### BEST MODE FOR CARRYING OUT THE INVENTION

### First Embodiment

FIG. 1 is a sectional view showing the structure of a cold cathode tube lamp 100 according to a first embodiment. FIG. 2 is an enlarged sectional view of a part of the cold cathode tube lamp 100 according to the first embodiment shown in FIG. 1. Referring to FIGS. 1 and 2, the cold cathode tube lamp 100 according to the first embodiment will now be described.

As shown in FIGS. 1 and 2, the cold cathode tube lamp 100 according to the first embodiment is provided with: a discharge tube composed of a glass tube 11 with an outer diameter (g) of 4 mm to 20 mm, preferably 3 mm to 10 mm, and with an inner diameter (f) of at least 3 mm or more, preferably 4 mm or more; and electrodes 21 and 22 forming a pair of cold cathodes disposed inside the glass tube 11 at opposite ends thereof. The electrode 21 (22) has the shape of a cup composed of a cylindrical portion 21a (22a)—having a cylindrical shape with an opening at one end—and a bottom portion 21b (22b)—closing the other end of the cylindrical portion 21a (22a). In the first embodiment, the electrode 21 (22) has an outer diameter (a) of 2 mm to 10 mm, preferably 2 mm to 3.5 mm, and has an overall length (b) of 4 mm to 20 mm, preferably 4 mm to 10 mm. In addition, the value of the ratio of the outer diameter (a) of the electrode to the overall length (b) of the electrode is a/b=0.5 to 1. The electrodes 21 and 22 are made of nickel (Ni), and can be formed by a pressing process, a ribbon process, or the like.

As shown in FIG. 1, lead terminals 31 and 32 are connected to the electrodes 21 and 22 respectively. The other ends of the lead terminals 31 and 32 are brought out of the glass tube 11, and the glass tube 11 is airtightly sealed and hermetically closed by the lead terminals 31 and 32. Although unillustrated, a fluorescent substance is applied to the interior wall of the glass tube 11, and a mixed gas of argon and neon along with mercury is sealed inside the glass tube 11. The lead terminals 31 and 32 are made of Nickel (Ni), and are welded to the electrodes 21 and 22 respectively. The lead terminals 31 and 32 have an outer diameter of 0.6 mm to 0.8 mm. The total gas pressure of a rare gas is 50 Torr or less, preferably 40 Torr or less.

In the first embodiment, as shown in FIGS. 1 and 2, a projecting portion 41 (42) having a substantially arc-shaped section is formed on the inner side surface of the cylindrical portion 21a (22a). In the first embodiment, as shown in FIG. 2, the projecting portion 41 (42) is formed within a region between a middle part with respect to the overall length (b) of the electrode 21 (22) and the opening of the cylindrical portion 21a (22a) so as to run along the inner circumference of the cylindrical portion 21a (22a). The projecting portion 41 (42) is made of a similar material of which the electrode 21 (22) is made, i.e., Nickel (Ni). The projecting portion 41 (42) may be formed integral with the electrode 21 (22), or the electrode 21 (22) and the projecting portion 41 (42) may be formed individually and then be formed by application of welding.

In the first embodiment, as a result of the projecting portion 41 (42) being formed on the inner side surface of the cylindrical portion 21a (22a), part of the ions or the like produced inside the glass tube 11 collide with the projecting portion 41 (42), and thus it is possible to prevent the ions or the like from entering a space region E formed by the bottom portion 21b (22b), the cylindrical portion 21a (22a), and the projecting portion 41 (42). This makes it possible to suppress occurrence of sputtering in a concentrated fashion on the interior surface of the bottom portion 21b (22b) and on the inner side surface of the cylindrical portion 21a (22a), and thus to suppress breakage of the electrode 21 (22) resulting from sputtering.

Moreover, part of the sputtered matter produced on the interior surface of the bottom portion 21b (22b) and on the inner side surface of the cylindrical portion 21a (22a) in the space region E collides with the projecting portion 41 (42), and thus it is possible to prevent the sputtered matter from scattering from the space region E into the glass tube 11. This makes it possible to suppress consumption of mercury ascribable to the sputtered matter combining with mercury, and thus it is possible to suppress diminished luminance in the cold cathode tube lamp and hence shorter life spans resulting from the reduction of mercury. In the first embodiment, the projecting portion 41 (42) is formed such that the value of the ratio of the thickness (d) of the projecting portion 41 (42) to the inner diameter (c) of the electrode 21 (22) is d/c= 1/20 to ¼. That is, the value of the ratio of the opening diameter (e) of a region in which the projecting portion 41 (42) is formed to the inner diameter (c) of the electrode 21 (22) is e/c= 1/10 to ½.

In the first embodiment, as described above, as a result of being provided with: the glass tube 11 having an inner diameter (f) of 3 mm or more; and a pair of electrodes 21 and 22 having an outer diameter (a) of 2 mm to 10 mm and an overall length (b) of 4 mm to 20 mm, a mixed gas of argon and neon being sealed in such that the total gas pressure of a rare gas is 50 Torr or less, it is possible, by passing a large current through the cold cathode tube lamp 100, to increase the luminance in the cold cathode tube lamp 100, and to enhance the light emission efficiency.

Moreover, since the projecting portions 41 and 42 are formed respectively on the inner side surfaces of the cylindrical portion 21a of the electrode 21 and the cylindrical portion 22a of the electrode 22, it is possible to suppress occurrence of sputtering in a concentrated fashion on the interior surface of the bottom part, and on the inner side surface of the cylindrical portion near the bottom part, of the electrodes 21 and 22. This makes it possible to suppress breakage of the electrodes resulting from sputtering. Furthermore, with the projecting portions 41 and 42, it is possible to prevent the sputtered matter produced by sputtering from scattering from the electrodes 21 and 22 into the glass tube 11 and combining with mercury, and thus possible to suppress consumption of mercury resulting from sputtering. It is therefore possible to suppress shortening of the life span of the cold cathode tube lamp resulting from breakage of the electrodes and consumption of mercury.

### Second Embodiment

FIG. 3 is a sectional view showing the structure of a cold cathode tube lamp 150 according to a second embodiment. FIG. 4 is a sectional view taken along line 500-500 in FIG. 3. Referring to FIGS. 3 and 4, the cold cathode tube lamp 150 according to the second embodiment will be described. In the second embodiment, such components as are similar to those in the first embodiment described previously are identified by common reference signs and their description will be omitted.

In the second embodiment, as shown in FIG. 3, a plurality (three) of lead terminals 33 (33a, 33b, and 33c) are connected to an electrode 21, and a plurality (three) of lead terminals 34 (34a, 34b, and 34c) are connected to an electrode 22. As shown in FIG. 3, the other ends of the plurality of lead terminals 33 and 34 are brought out of the glass tube 11, and the glass tube 11 is airtightly sealed and hermetically closed by the plurality of lead terminals 33 and 34. The lead terminals 33 and 34 each have an outer diameter of 0.6 mm to 0.8 mm.

In the second embodiment, as shown in FIG. 4, the three lead terminals 33 (34) are so arranged that, as seen on a plane, the polygonal shape formed by the three lead terminals is equilateral-triangular, and that the center of gravity of the equilateral-triangular shape approximately coincides with the center of a bottom part of the electrode 21 (22). Arranging the three lead terminals 33 (34) in this way permits the lead terminals 33 (34) to be arranged in good balance physically; thus, even when the electrode 21 (22) is given a larger outer diameter, the electrode 21 (22) can be supported securely in good balance. This helps reduce the load on the individual lead terminals 33 (34), and thus helps suppress deformation or breakage in the lead terminals 33 (34) at the joint between the electrode 21 (22) and the lead terminals 33 (34). In this way, it is possible to suppress shortening of the life span of the cold cathode tube lamp resulting from deformation or breakage at the joint between the electrode and the lead terminals.

Moreover, as a result of the three lead terminals 33 (34) being connected to the electrode 21 (22), the heat generated in the electrode 21 (22) is dissipated via each of the three lead terminals 33 (34); thus, even when the electrode 21 (22) is given a larger outer diameter and a larger amount of heat is generated, the generated heat can be dissipated efficiently via each of the three lead terminals 33 (34). In this way, it is possible to suppress inconveniences such as mercury re-absorbing released ultraviolet radiation ascribable to the heat generated in the electrode 21 (22) reaching the glass tube and thus the temperature of the tube wall of the glass tube being raised, and thus it is possible to suppress lowered light emission efficiency. Moreover, since the heat generated in the electrode 21 (22) is dissipated via each of the three lead terminals 33 (34), it is possible to suppress damage, caused by the heat concentrating on any one of the lead terminals 33 (34), to an end metal or circumferential connector connected to the lead terminals.

In other respects, the configuration of the second embodiment is similar to that of the first embodiment described previously.

### Third Embodiment

FIG. 5 is a schematic diagram of a lighting device 200 for liquid crystal display device, the lighting device 200 employing the cold cathode tube lamp 100 according to the first embodiment. FIG. 6 is a sectional schematic diagram taken along line 600-600 in FIG. 5. Next, the display-device-oriented lighting device 200 according to the third embodiment will be described with reference to FIGS. 5 and 6. In the third embodiment, such components as are similar to those in the first embodiment described previously are identified by common reference signs and their description will be omitted.

As shown in FIG. 5, the display-device-oriented lighting device 200 is provided with the following: a group of discharge tubes comprising a plurality of cold cathode tube lamps 100 arranged in parallel; cold cathode tube lamp holding members 51 (51a and 51b) holding the plurality of cold cathode tube lamps 100 forming the group of discharge tubes; a reflective composite member 52 disposed below the group of discharge tubes and reflecting the light emitted downward from the group of discharge tubes; and a back chassis 53 keeping the group of discharge tubes in a fixed position. As shown in FIGS. 5 and 6, the cold cathode tube lamp holding members 51 (51a and 51b) are arranged at opposite positions so as to hold the lead terminals 31 and 32 of each of the plurality of cold cathode tube lamps 100. In this way, the plurality of cold cathode tube lamps 100 are collectively positioned and held by the cold cathode tube lamp holding members 51 (51a and 51b). The reflective composite member 52 is composed of, for example, a metal plate of aluminum or the like and a reflective sheet of resin affixed to the top surface of the metal plate. The back chassis 53 closes the group of discharge tubes in, and has the functions of keeping the strength of the display-device-oriented lighting device and of dissipating the heat generated in the group of discharge tubes (cold cathode tube lamps 100). Although unillustrated, a set of optical sheets 67, which will be described later, is arranged on the top face of the group of discharge tubes, that is, in front of the reflective composite member 52.

As shown in FIG. 5, the plurality of cold cathode tube lamps 100 are arranged in parallel, and as shown in FIG. 6, the lead terminals 31 and 32 of the cold cathode tube lamps 100 are held by the cold cathode tube lamp holding members 51a and 51b. On the back face of the back chassis 53, an unillustrated power supply is provided, and the cold cathode tube lamp holding members 51 (51a and 51b) are electrically connected to the power supply directly or via a connector or the like. Thus, alternating-current voltages of opposite phases are applied to the electrodes 21 and 22 (see FIG. 1) of the cold cathode tube lamps 100 via their respective lead terminals 31 and 32, which allows each of the cold cathode tube lamps 100 to emit light.

Since the display-device-oriented lighting device 200 according to the third embodiment is provided with the cold cathode tube lamp 100 according to the first embodiment as described above, it is possible to suppress shortening of the life span of the cold cathode tube lamp resulting from sputtering. This makes it possible to suppress inconveniences such as diminished luminance in the display-device-oriented lighting device ascribable to shortening of the life span of the cold cathode tube lamp.

### Fourth Embodiment

FIG. 7 is an exploded perspective view of a liquid crystal display device 300 provided with a display-device-oriented lighting device 200 according to a fourth embodiment. Next, referring to FIG. 7, the liquid crystal display device 300 according to the fourth embodiment will be described. In the fourth embodiment, such components as are similar to those in the first and the third embodiments described previously are identified by common reference signs and their description will be omitted.

As shown in FIG. 7, the liquid crystal display device 300 is provided with, above the display-device-oriented lighting device according to the third embodiment, the following: a set of optical sheets 67; a liquid crystal panel 62 displaying an image; a front chassis 63 keeping the liquid crystal panel 62 in a fixed position; and a bezel 61 protecting the liquid crystal panel 62. The set of optical sheets 67 comprises resin sheets diffusing, condensing, and otherwise acting upon the light they transmit, and has, for example, a diffuser sheet 64, a prism sheet 65, and a diffuser sheet 66 laid on one another in this order from the top. The number and combination of individual sheets in the set of optical sheets 67 may be changed as desired. The bezel 61 has the shape of a frame having an inverted-L-section, and has openings formed at positions corresponding to insertion portions formed on the outer side surfaces of the cold cathode tube lamp holding members 51 (51a and 51b). The front chassis 63 has the shape of a frame having an inverted-L-section and, like the bezel 61, has openings formed at positions corresponding to the insertion portions formed on outer side surfaces of the cold cathode tube lamp holding members 51 (51a and 51b). This permits the bezel 61, the liquid crystal panel 62, the front chassis 63, the set of optical sheets 67, and the display-device-oriented lighting device 200 to be fitted together.

In the fourth embodiment, as described above, the display-device-oriented lighting device 200 provided with the cold cathode tube lamp 100 is arranged on the back face of the liquid crystal panel 62 and other components are arranged, so that the light emitted from the cold cathode tube lamp 100 is directed to the liquid crystal panel 62. This permits an image and the like to be displayed on the liquid crystal panel 62.

Since the display device 300 according to the fourth embodiment is provided with the display-device-oriented lighting device 200 having the cold cathode tube lamp 100 as described above, it is possible to suppress inconveniences such as diminished luminance in the display device 300 resulting from shortening of the life span of the cold cathode tube lamp 100, and thus to enhance the reliability of the display device 300.

Although the fourth embodiment deals with a liquid crystal display device, this is in no way meant as a limitation; the cold cathode tube lamp according to the invention may be applied to any display devices other than liquid crystal display devices.

Moreover, the liquid crystal display device according to the fourth embodiment described above can be employed, for example, in television receiving devices. A television receiving device according to the invention is provided with, for example, a terrestrial wave antenna, a television reception tuner, an output portion, a keyboard, a storage portion, a GPS reception antenna, a television reception portion, a GPS reception portion, and a control portion. The liquid crystal display device according to the fourth embodiment described above can be used as a display for reproduction from video and audio signals obtained through conversion by an MPEG2 decoder or video/audio decoder, and forms along with a speaker or the like the output portion mentioned above.

Since the television receiving device described above is provided with the display device 300 according to the fourth embodiment, inconveniences such as diminished luminance in the display device 300 resulting from shortening of the life span of the cold cathode tube lamp 100 employed in the display-device-oriented lighting device 200 of the display device 300. Thus, it is possible to enhance the reliability of the television receiving device.

The embodiments disclosed herein are to be considered in all respects as illustrative and not restrictive. The scope of the present invention is set out in the appended claims and not in the description of the embodiments hereinabove, and includes any variations an modifications within the sense and scope equivalent to those of the claims.

For example, although the first to fourth embodiments described above deal with examples in which a mixed gas of argon and neon is sealed inside a glass tube, this is in no way meant as a limitation; any rare gas other than argon or neon may instead be sealed in. Specifically, examples of such rare gases include xenon and krypton.

Although the first to fourth embodiments described above take up, as an example, electrodes made of nickel (Ni), this is in no way meant as a limitation; any metal material other than nickel (Ni) may instead be used. Specifically, examples of such metal materials include niobium (Nb), molybdenum (Mo), tungsten (W), etc.

Although the first to fourth embodiments described above take up, as an example, lead terminals made of nickel (Ni), this is in no way meant as a limitation; lead terminals made of any metal material other than nickel (Ni) may instead be used. Examples of metal materials other than nickel (Ni) include, for example, copper (Cu), tungsten (W), etc. Electrodes and lead terminals may be made of the same metal material, or may be made of different metal materials.

Although the first and second embodiments described above deal with examples in which a projecting portion having a substantially arch-shaped section is formed, this is in no way meant as a limitation; the projecting portion may have any section shape other than an arc shape.

Although the second embodiment described above deals with an example in which three lead terminals are employed, this is in no way meant as a limitation; a plurality of lead terminals may be at least two or more. Moreover, the shape formed by lead terminals may be other than equilateral-polygonal, so long as the lead terminals are arranged such that the center of gravity of the polygonal shape formed by the lead terminals approximately coincides with the center of a bottom part of an electrode. Moreover, the shape formed by the lead terminals may be other than polygonal, so long as at least two of the plurality of lead terminals are arranged, as seen on a plane, at opposite positions across the center of a bottom part of the electrode. Furthermore, one of the plurality of lead terminals may be arranged at the center of a bottom part of the electrode.

Although the third and fourth embodiments described above deal with examples in which the cold cathode tube lamp according to the first embodiment described previously is employed, this is in no way meant as a limitation; any cold cathode tube lamp within the scope of the appended claims, including the cold cathode tube lamp according to the second embodiment described previously, may instead be employed.

Although the fourth embodiment described above adopts, as an example, a construction in which a display-device-oriented lighting device provided with a cold cathode tube lamp is arranged on the back face of a liquid crystal panel, that is, a direct-lit type construction, this is in no way meant as a limitation; an edge-lit type construction may instead be adopted in which a display-device-oriented lighting device provided with a cold cathode tube lamp is arranged at an edge of a liquid crystal panel.

1. A cold cathode tube lamp comprising a discharge tube composed of a glass tube having at least a rare gas sealed therein and a pair of electrodes arranged opposite each other inside the glass tube at opposite ends thereof,
wherein the electrodes have a cylindrical portion having a cylindrical shape with an opening at one end and a bottom portion closing the other end of the cylindrical portion, and
wherein, on an inner side surface of the cylindrical portion, a projecting portion is formed.

2. The cold cathode tube lamp according to claim 1,
wherein the projecting portion is formed in a region between the opening and a middle part with respect to an overall length of the electrodes.

3. The cold cathode tube lamp according to claim 1,
wherein the projecting portion has a thickness of 1/20 times to ¼ times an inner diameter of the electrodes.

4. The cold cathode tube lamp according to claim 1,
wherein the electrodes have an outer diameter of 0.5 times to 1.0 time an overall length of the electrodes.

5. The cold cathode tube lamp according to claim 1,
wherein the glass tube has an inner diameter of 3 mm or more.

6. The cold cathode tube lamp according to claim 1,
wherein a total gas pressure of a rare gas sealed inside the glass tube is 50 Torr or less.

7. The cold cathode tube lamp according to claim 1,
wherein, for each of the electrodes, there are arranged a plurality of lead terminals that are, at one end, connected to the corresponding electrode and are, at the other end, brought out of the glass tube.

8. The cold cathode tube lamp according to claim 1,
wherein the electrodes are made of at least one metal material selected from a group of W, Nb, Mo, and Ni.

9. A lighting device for display device, comprising the cold cathode tube lamp according to claim 1.

10-11. (canceled)

12. A lighting device for display device, comprising the cold cathode tube lamp according to claim 2.

13. A lighting device for display device, comprising the cold cathode tube lamp according to claim 3.

14. A lighting device for display device, comprising the cold cathode tube lamp according to claim 4.

15. A lighting device for display device, comprising the cold cathode tube lamp according to claim 5.

16. A lighting device for display device, comprising the cold cathode tube lamp according to claim 6.

17. A lighting device for display device, comprising the cold cathode tube lamp according to claim 7.

18. A lighting device for display device, comprising the cold cathode tube lamp according to claim 8.

19. A display device comprising the lighting device for display device according to claim 9.

20. A display device comprising the lighting device for display device according to claim 12.

21. A display device comprising the lighting device for display device according to claim 13.

22. A display device comprising the lighting device for display device according to claim 14.

23. A display device comprising the lighting device for display device according to claim 15.

24. A display device comprising the lighting device for display device according to claim 16.

25. A display device comprising the lighting device for display device according to claim 17.

26. A display device comprising the lighting device for display device according to claim 18.

27. A television receiving device comprising the display device according to claim 19.

28. A television receiving device comprising the display device according to claim 20.

29. A television receiving device comprising the display device according to claim 21.

30. A television receiving device comprising the display device according to claim 22.

31. A television receiving device comprising the display device according to claim 23.

32. A television receiving device comprising the display device according to claim 24.

33. A television receiving device comprising the display device according to claim 25.

34. A television receiving device comprising the display device according to claim 26.
